(19) United States
(12) Patent Application Publication
(10) Pub. No.: US 2024/0150150 A1
(43) Pub. Date: May 9, 2024

(54) HELICOPTER CONDUCTOR REEL PAYOUT DOLLY

(71) Applicant: PACIFIC GAS AND ELECTRIC COMPANY, San Francisco, CA (US)

(72) Inventors: Robert Borello, Chico, CA (US); Wilson Wong, San Martin, CA (US); Leonard Goldberg, Fremont, CA (US); Vernal Garcia, San Francisco, CA (US)

(21) Appl. No.: 18/502,252

(22) Filed: Nov. 6, 2023

Related U.S. Application Data
(60) Provisional application No. 63/422,541, filed on Nov. 4, 2022.

(51) Int. Cl. B65H 49/22; B65H 57/14; B65H 59/04; H02G 1/02

(52) U.S. Cl. CPC B65H 49/22; B65H 57/14; B65H 59/04; H02G 1/02; B65H 2701/36

(57) ABSTRACT

Some embodiments of the disclosure are directed to a dolly for unrolling the payload wrapped on a reel from a helicopter. In some embodiments, the dolly includes one or more of a main frame, a fairlead frame, and a reel shaft. In some embodiments, the main frame is configured to hold the reel shaft. In some embodiments, the main frame is configured to hold the cable reel. In some embodiments, the fairlead frame is pivotably attached to the main frame. In some embodiments, the fairlead frame is configured to guide a cable away from the cable reel. In some embodiments, the dolly further comprises a tether configured to limit a pivot range between the main frame and the fairlead frame. In some embodiments, the dolly further comprises a brake belt. In some embodiments, the brake belt is configured to limit a rotation of the cable reel about the reel shaft.

### CROSS-REFERENCE TO RELATED APPLICATION

This application claims priority and benefit of U.S. Provisional Application No. 63/422,541, filed Nov. 4, 2022, the contents of which are incorporated herein by reference in its entirety.

### BACKGROUND

Conductor reels are used by various organizations including utilities that provide electrical conductors for distribution or transmission lines. Such conductors must be installed or sometimes periodically replaced. Overhead conductors often traverse significant distances and challenging terrain.

Currently, this installment or replacement is accomplished by using utility trucks with conductor reels mounted to a dispenser mounted in the back of the truck on a trailer. This method can be very challenging and time consuming, especially in areas where the terrain is not suitable for easy access by truck or laying of conductor, including, but not limited to, mountainous regions, heavily wooded areas, bodies of water, and deep ravines.

Accordingly, a need exists for a conductor reel that can more easily be maneuvered into difficult terrain. Ideally, such a system would efficiently and reliably dispense conductors, especially in areas where conventional dispensing methods are cumbersome or challenging.

### SUMMARY

Some embodiments of the disclosure are directed to a dolly for unrolling a conductor reel (generally referred to as a cable reel) from an aircraft capable of hovering (referred to herein for simplicity as a “helicopter.”) In some embodiments, the dolly includes one or more of a main frame, a fairlead frame, and a reel shaft. In some embodiments, the main frame is configured to hold the reel shaft, which passes through the center of a cable reel during assembly. In some embodiments, the main frame is configured to hold the cable reel and/or the reel shaft. In some embodiments, the fairlead frame is pivotably attached to the main frame. In some embodiments, the fairlead frame is configured to guide a cable away from the cable reel.

In some embodiments, the dolly further comprises a tether configured to limit a pivot range between the main frame and the fairlead frame. In some embodiments, the dolly further comprises a brake belt. In some embodiments, the brake belt is configured to limit a rotation speed of the cable reel about the reel shaft to control a rolling motion. In some embodiments, the brake belt includes one or more detachable weights configured to increase friction on the cable reel.

In some embodiments, the fairlead frame comprises one or more rollers. In some embodiments, the one or more rollers are configured to guide the cable away from the cable reel.

In some embodiments, the main frame comprises one or more cable guides. In some embodiments, the one or more cable guides are configured to secure a helicopter tether connection to the main frame. In some embodiments, the one or more cable guides comprise a plurality of fasteners. In some embodiments, the plurality of fasteners are configured to confine a tether between walls of the one or more cable guides.

In some embodiments, the main frame further includes one or more journal plates configured to support a journal. In some embodiments, the one or more journal plates include a journal configured to support the reel shaft. In some embodiments, the journal includes one or more fasteners configured to prevent rotation of the reel shaft within the journal.

In some embodiments, the dolly and/or reel shaft comprises one or more locking hubs. In some embodiments, each of the one or more locking hubs is configured to secure the tether to the reel shaft. In some embodiments, each of the one or more locking hubs is configured to prevent the tether from sliding off an end of the reel shaft. In some embodiments, each of the one or more locking hubs comprise fasteners configured to prevent a lateral and/or rotational movement when coupled to the reel shaft.

### BRIEF DESCRIPTION OF DRAWINGS

FIG. 1 depicts an assembled helicopter dolly according to some embodiments.

FIG. 2 illustrates an assembled view of a non-limiting helicopter conductor reel payout dolly according to some embodiments.

FIG. 3 shows a close-up view of a location A where a reel shaft connects to the outside of a main frame according to some embodiments.

FIG. 4 portrays a close-up view of a location B where a fairlead frame connects to the main frame according to some embodiments.

FIG. 5 displays a close-up view of a location C where the reel shaft connects to the inside of the main frame from the overall assembly view of the helicopter conductor reel payout dolly in FIG. 2 according to some embodiments.

FIG. 6 exhibits a front view of a main frame according to some embodiments.

FIG. 7 illustrates a close-up view of a D from the main frame in FIG. 6 according to some embodiments.

FIG. 8 depicts a close-up view of a side bar H from the main frame in FIG. 6 according to some embodiments.

FIG. 9 illustrates a close-up view of a top bar K from the main frame in FIG. 6 according to some embodiments.

FIG. 10 shows a side view of main frame according to some embodiments.

FIG. 11 portrays a close-up view of a journal plate E from the main frame in FIG. 10 according to some embodiments.

FIG. 12 displays a close-up view of a bracket F from the main frame in FIG. 10 according to some embodiments.

FIG. 13 exhibits a close-up view of a metal support segment J from the main frame in FIG. 10 according to some embodiments.

FIG. 14 demonstrates a side view of a fairlead frame according to some embodiments.

FIG. 15 depicts a close-up view of a conveyor rollers holder G from the fairlead frame in FIG. 14 according to some embodiments.

FIG. 16 illustrates a close-up view of a bracket L from the fairlead frame in FIG. 14 according to some embodiments.

FIG. 17 shows a top view of fairlead frame according to some embodiments.

FIG. 18 portrays a close-up view of a conveyor rollers holder M from the fairlead frame 103 in FIG. 17 according to some embodiments.

FIG. 19 displays an angled view of a main frame according to some embodiments.

FIG. 20 exhibits a close-up view of a bracketed corner bar N from the main frame in FIG. 19 according to some embodiments.

FIG. 21 shows an angled view of a fairlead frame according to some embodiments.

FIG. 22 portrays a reel shaft according to some embodiments.

FIG. 23 displays a bar of the reel shaft in FIG. 22 according to some embodiments.

FIG. 24 shows a front view of a cylinder from the reel shaft in FIG. 22 according to some embodiments.

FIG. 25 exhibits a side view of a cylinder from the reel shaft in FIG. 22 according to some embodiments.

FIG. 26 illustrates a brake belt according to some embodiments.

FIG. 27 depicts a zoomed in portion of the brake belt in FIG. 26 according to some embodiments.

FIG. 28 illustrates a helicopter conductor reel payout dolly on the ground according to some embodiments.

FIG. 29 shows a helicopter conductor reel payout dolly with a conductor reel installed according to some embodiments.

FIG. 30 portrays a front view of a helicopter conductor reel payout dolly in use according to some embodiments.

FIG. 31 displays a back view of a helicopter conductor reel payout dolly in use according to some embodiments.

FIG. 32 depicts a brake belt assembly that includes one or more steal backing plates according to some embodiments.

FIG. 33 illustrates a measured thickness of a brake belt according to some embodiments.

FIG. 34 shows how the brake belt is configured to connect to the bracketed bar N according to some embodiments.

FIG. 35 shows a perspective image of location C from FIG. 2 according to some embodiments.

FIG. 36 shows a top image of location C from FIG. 2 according to some embodiments.

FIG. 37 illustrates cables attached to sidebar H from FIG. 6 in an assembled helicopter dolly according to some embodiments.

FIG. 38 depicts a close-up view of the support chain from FIG. 4 according to some embodiments.

### DETAILED DESCRIPTION

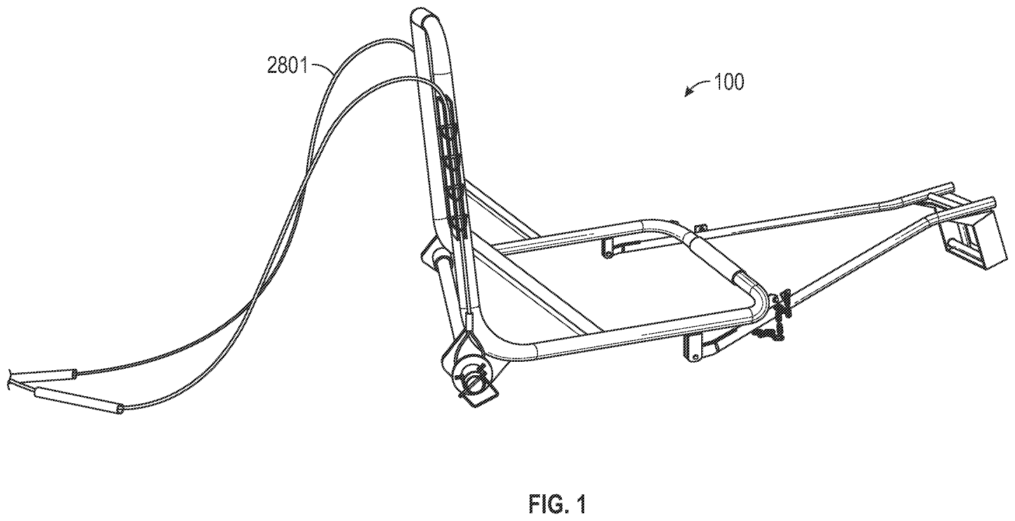

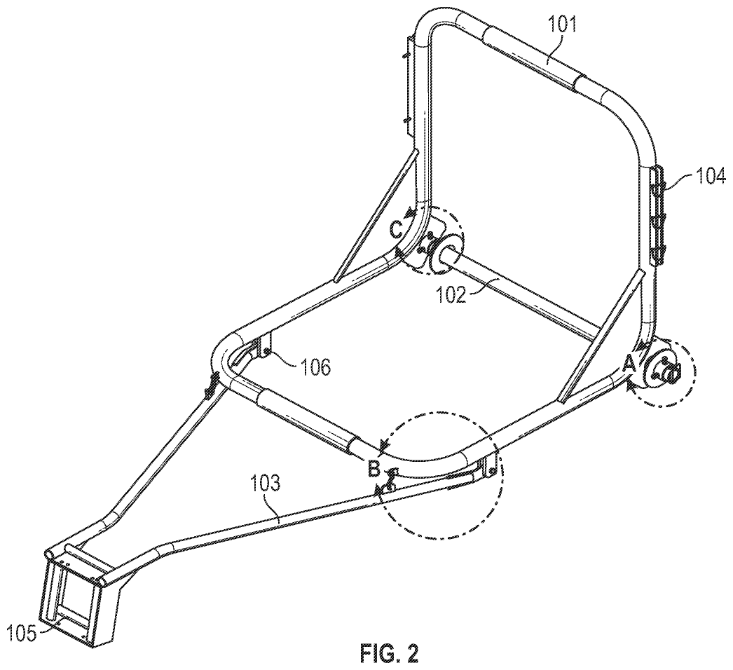

FIG. 1 depicts an assembled helicopter dolly including a helicopter sling 2801 according to some embodiments. FIG. 2 illustrates an overall assembly view of a helicopter conductor reel payout dolly according to some embodiments. In some embodiments, the helicopter conductor reel payout dolly (the “dolly”) includes one or more of a main frame 101, a reel shaft 102, a fairlead frame 103. In some embodiments the main frame comprises various wire-locks 103 for simplified removal of cables, reels, and components. The term cable and/or tether as used herein are a broad terms which include cables, chains, ropes, and/or any deformable elongated material, and the terms are interchangeable when describing the metes and bounds of the system according to some embodiments.

In some embodiments, a location A indicates where the reel shaft 102 connects to the outside of the main frame 101. In some embodiments, a location B indicates where the fairlead frame 103 connects to the main frame 101. In some embodiments, a location C indicates where the reel shaft 102 connects to the inside of the main frame 101. In some embodiments, the fairlead frame 103 includes one or more conveyor rollers 105. In some embodiments, the fairlead frame 103 is configured to be positioned to the rear relative to the direction of helicopter travel.

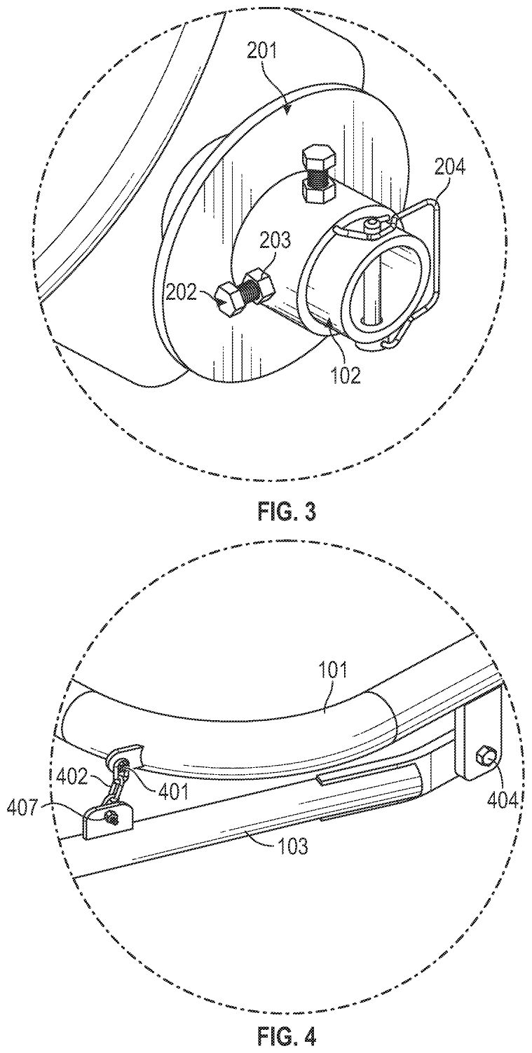

FIG. 3 shows a close-up view of a location A where reel shaft 102 connects to the outside of main frame 101 as shown in the overall assembled view of the helicopter conductor reel payout dolly in FIG. 2 according to some embodiments. In some embodiments, the reel shaft 102 is connected to a locking hub 201 by one or more fasteners. In some embodiments, non-limiting examples of fasteners include one or more screws 202, one or more nuts 203, and/or one or more wire-locks 204, and/or other desired retention devices. While the specific example shown in the Figures uses various screws, nuts, bolts, wire-locks, etc., it is understood that these species can are interchangeable with the genus fastener when defining the metes and bounds of the system.

FIG. 4 portrays a close-up view of location B in FIG. 1 where a fairlead frame 103 connects to main frame 101 from the overall assembly view of the helicopter conductor reel payout dolly in FIG. 2 according to some embodiments. In some embodiments, the fairlead frame 103 is connected to the main frame 101 via one or more screws 404. In some embodiments, the fairlead frame 103 is connected to the main frame 101 via one or more screws 401 and one or more locknuts 403 connected by one or more chains 402, which may be replaced with any suitable tether according to some embodiments. In some embodiments, the fairlead frame 103 is configured to have some (controlled) vertical movement with respect to the main frame 101 by use of pivot points 106 generally located at screws 404. In some embodiments, the combination of the pivot points 106 and the chains 402 reduce mechanical moments that may stress the main frame 101 during use, take-off, and landing of a helicopter. In some embodiments, the pivot points 106 are also configured to allow for smooth payout unloading as the helicopter travels and changes direction.

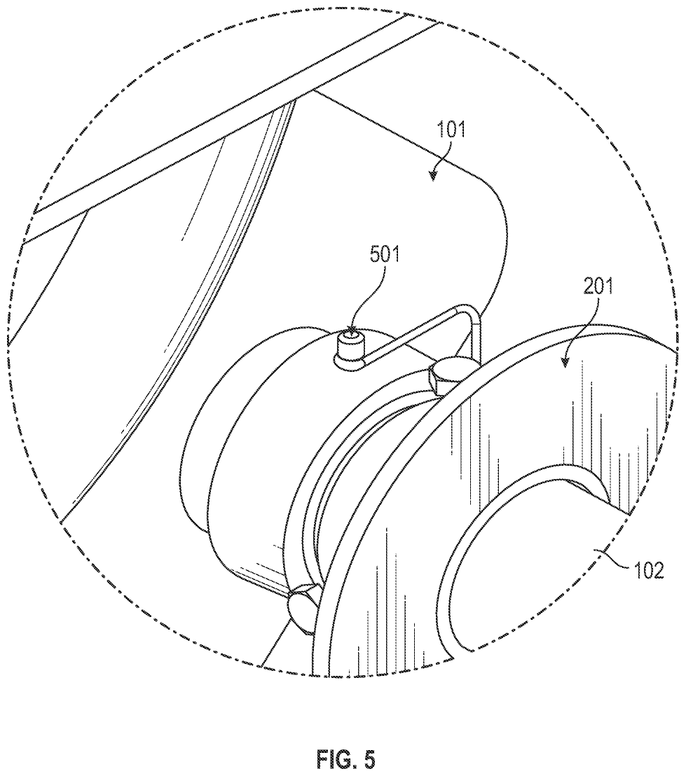

FIG. 5 displays a close-up view of a location C where the reel shaft 102 connects to the inside of the main frame 101 from the overall assembly view of the helicopter conductor reel payout dolly in FIG. 2 according to some embodiments. In some embodiments, the main frame 101 is connected to a locking hub 201 by a wire-lock (clevis pin) 501.

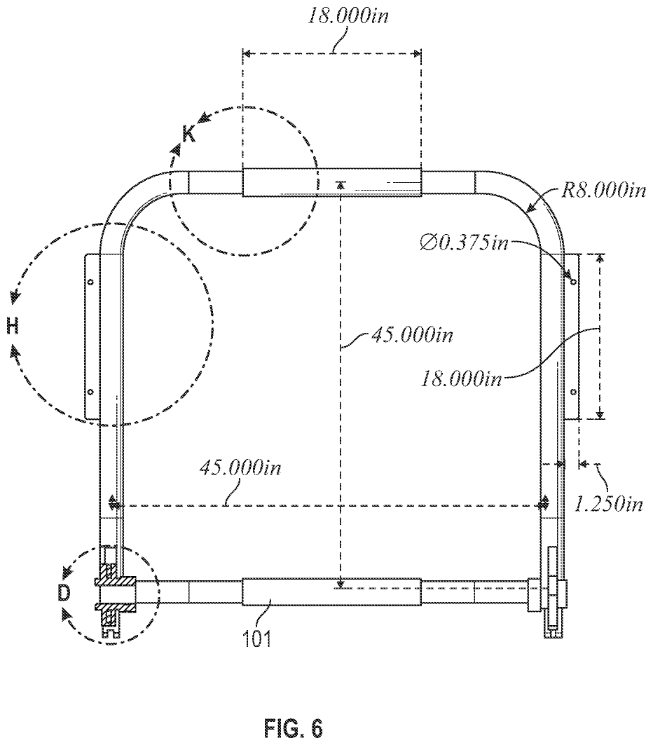

FIG. 6 exhibits a front view of a main frame 101 according to some embodiments. In some embodiments the main frame 101 is comprised of a section D, a side bar H, and a top bar K.

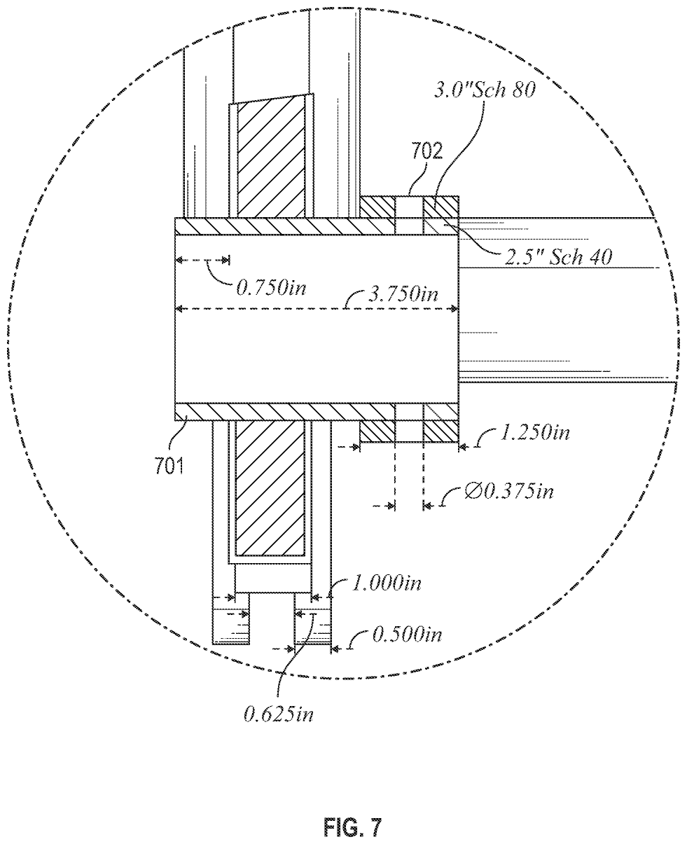

FIG. 7 demonstrates a close-up view of a section D from the main frame 101 in FIG. 6 according to some embodiments. In some embodiments, section D comprises a shaft journal 701 and a cotter pin shaft 702 configured to hold the main shaft 102 in a stationary position. According to a method of assembly, the reel shaft 102 is removed by sliding it out the shaft journals 701, the main frame 101 is positioned over and/or on either side of a conductor reel 2901 (see FIG. 29), and the reel shaft 102 is reinserted into the shaft journals 701 and secured in position by one or more fasteners (e.g., wire-lock 501) according to some embodiments.

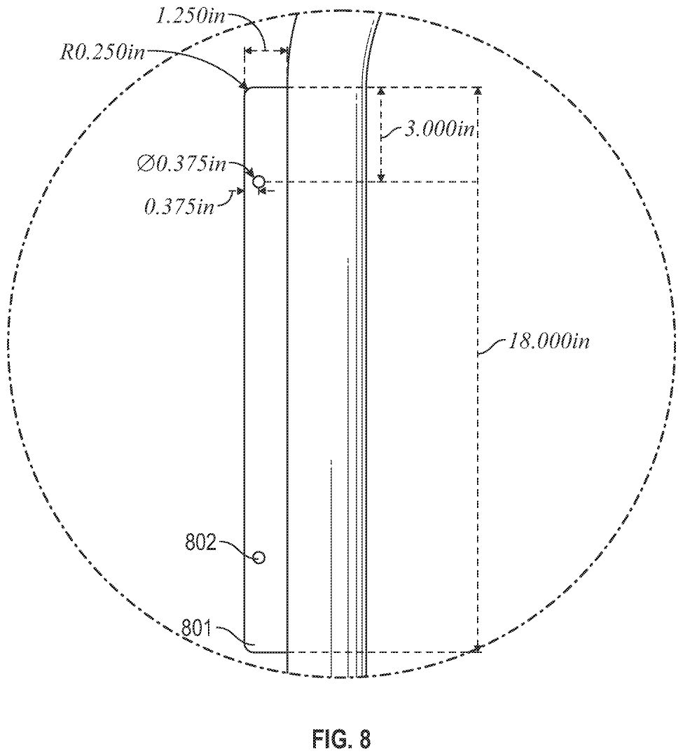

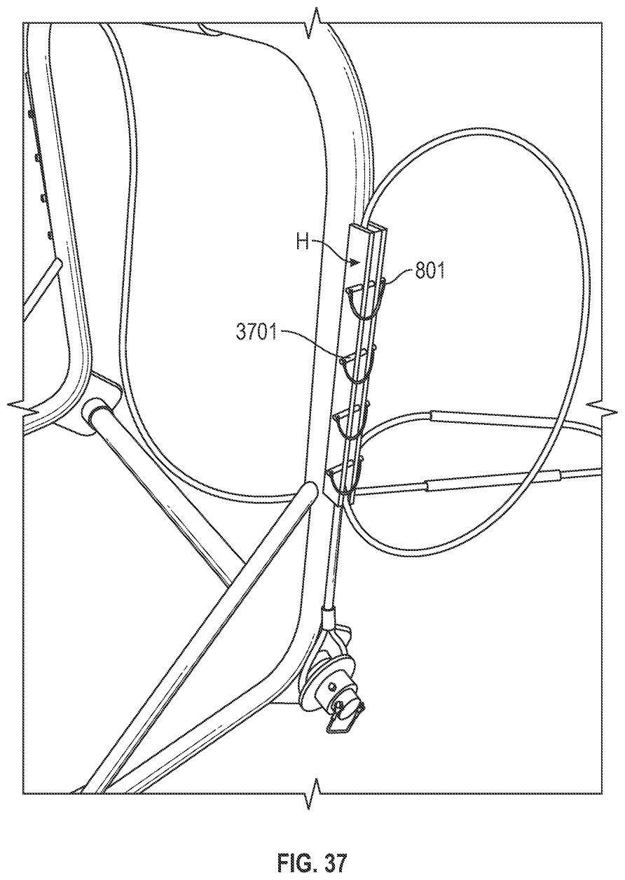

FIG. 8 depicts a close-up view of side bar H of the main frame 101 in FIG. 6 according to some embodiments. In some embodiments, the side bar H comprises one or more cable guides 801. In some embodiments, each side of the main frame 101 comprises two cable guides 801 configured to enable a sling 2801 to fit therebetween (see FIG. 37). In some embodiments, the sling 2801 (e.g., cable sling, rope sling, etc.) is held in place by one or more fasteners (e.g., wire-locks) placed in retention holes 802. In some embodiments, the retention holes 802 are configured to enable the fastener to secure the sling (e.g., cable, rope) between the walls formed by cable guides 801 and the main frame 101.

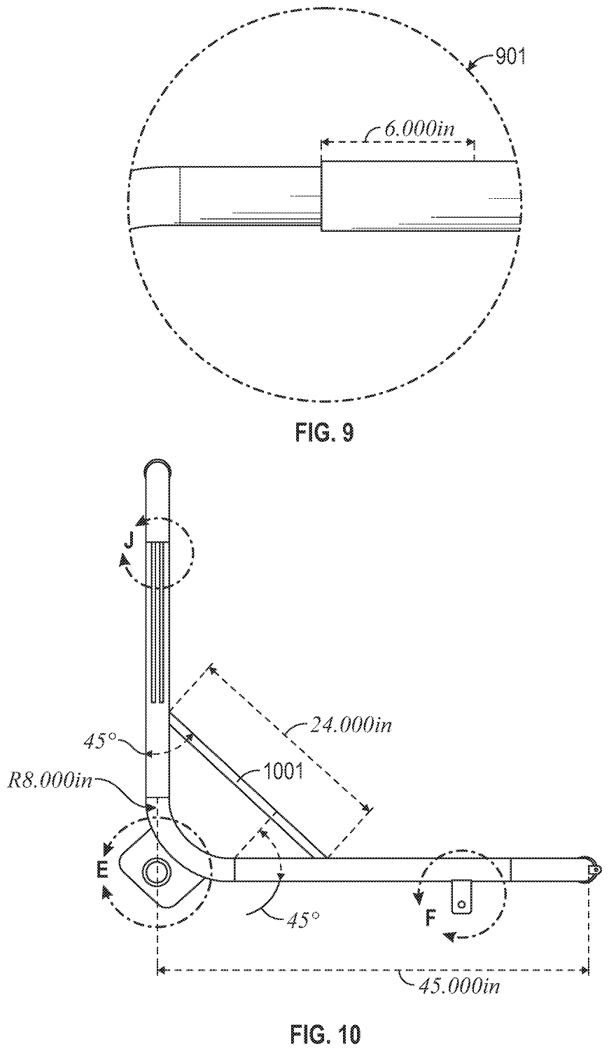

FIG. 9 illustrates a close-up view of a top bar K from the main frame 101 in FIG. 6 according to some embodiments. In some embodiments, the main frame 101 includes a large diameter portion 901 configured to add additional strength to the upper portion of the main frame 101.

FIG. 10 shows a side view of the main frame 101 according to some embodiments. In some embodiments, the main frame 101 includes a moment plate 1001 configured to add rigidity to the main frame 101.

FIG. 11 portrays a close-up view of a journal plate section E from the main frame 101 in FIG. 10 according to some embodiments. In some embodiments, the journal plate 1101 is configured to support one or more journals 701.

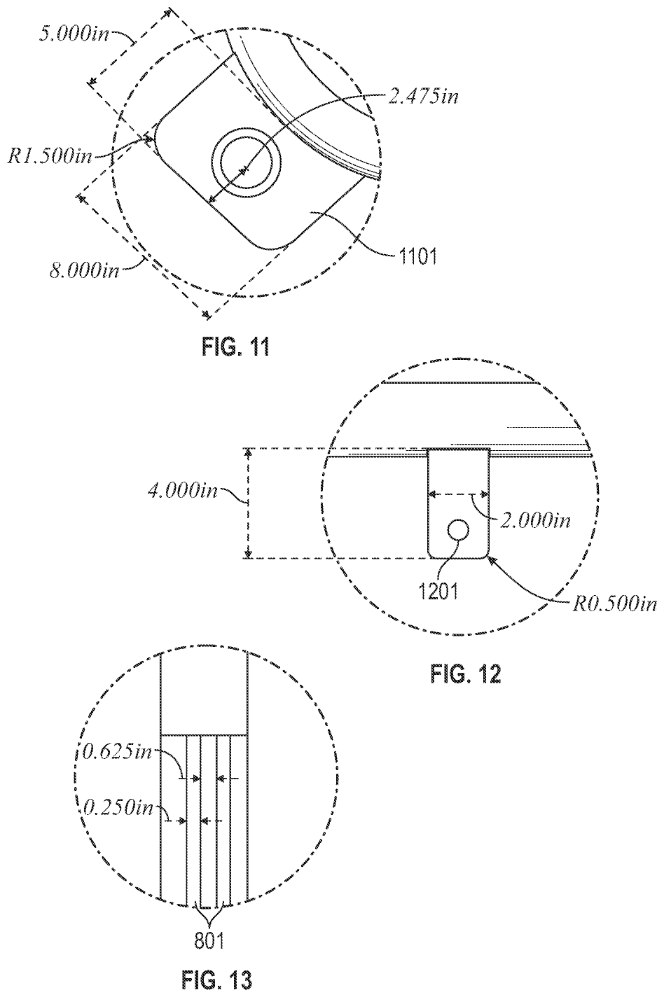

FIG. 12 displays a close-up view of a bracket F from the main frame 101 in FIG. 10 according to some embodiments. In some embodiments the bracket F is configured to connect to the main frame 101 to the fairlead frame 103 (not shown) via chains 4 connected to tether hole 1201.

FIG. 13 exhibits an side view of the side bar H showing dimensions of cable guides 801 according to some embodiments.

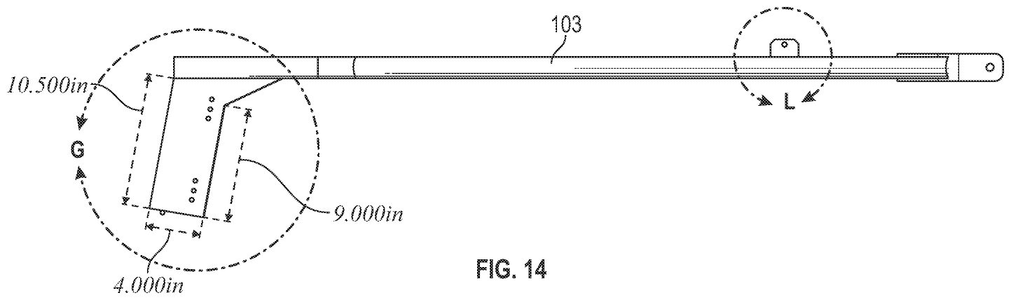

FIG. 14 illustrates a side view of a fairlead frame 103 according to some embodiments. In some embodiments the fairlead frame 103 comprises a conveyor rollers holder G and a bracket L. In some embodiments, the conveyor rollers holder section G comprises one or more conveyor rollers 105 configured to facilitate the feeding of an electrical line (or other desired rolled product) from an attached spool.

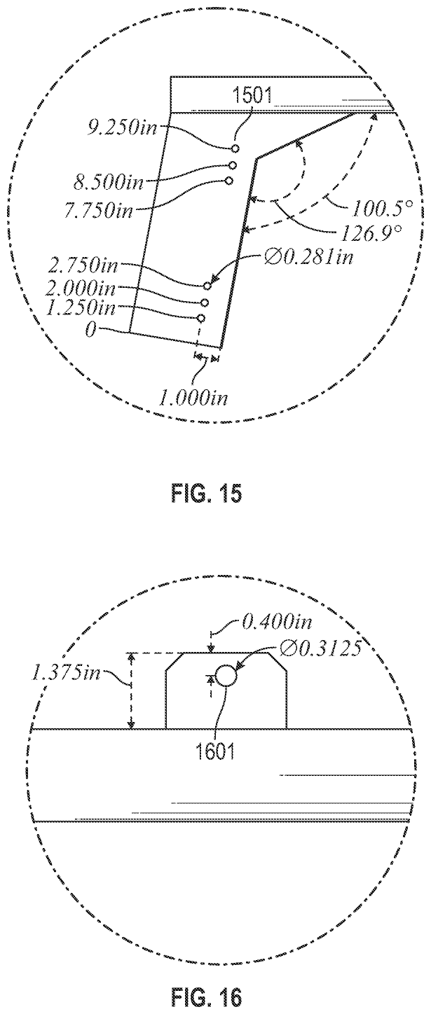

FIG. 15 depicts a close-up view of a conveyor rollers holder G from the fairlead frame 103 in FIG. 14 according to some embodiments. In some embodiments, the conveyor rollers holder G is configured to hold a conveyor roller 105. In some embodiments, the conveyor rollers holder G comprises one or more fasting holes 1501 configured to engage one or more fasteners to secure the one or more conveyor rollers 105 to the conveyor rollers holder G according to some embodiments.

FIG. 16 illustrates a close-up view of a bracket L from the fairlead frame 103 in FIG. 14 according to some embodiments. In some embodiments the bracket L is configured to connect the fairlead frame 103 to a tether hole 1201 in main frame 101 via one or more fairlead tether holes 1601. In some embodiments, the one or more tethers 110 (e.g., cables) are coupled to one or more tether holes on the fairlead frame and/or the main frame.

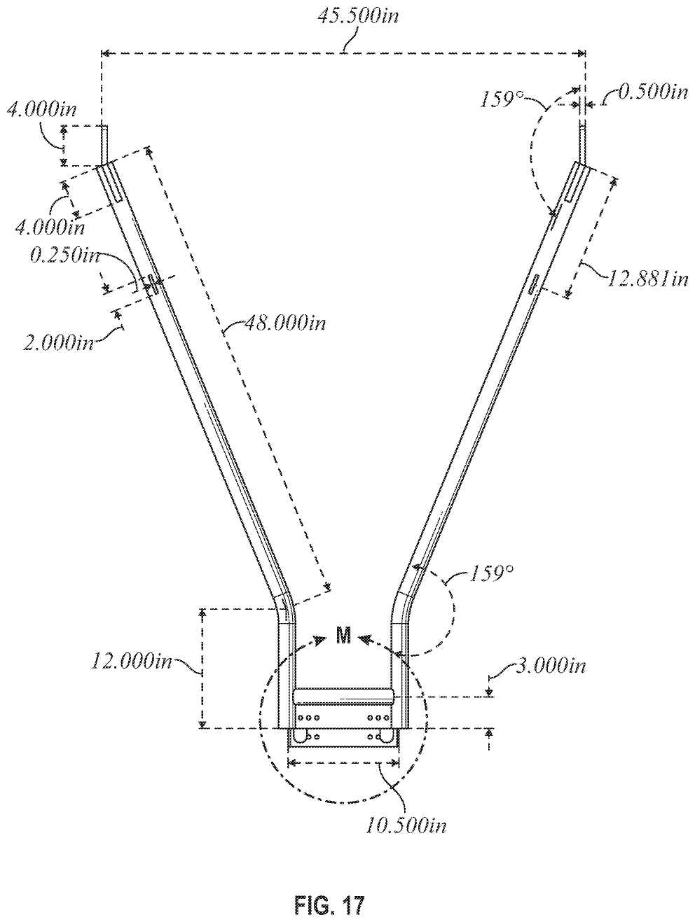

FIG. 17 shows a top view of a fairlead frame 103 according to some embodiments.

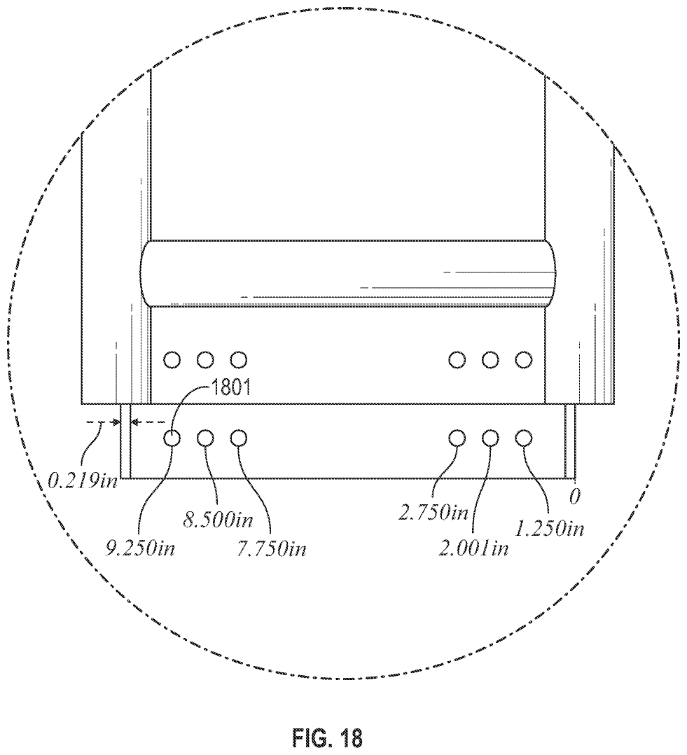

FIG. 18 shows a close-up view of a conveyor rollers holder M from the fairlead frame 103 in FIG. 17 according to some embodiments. In some embodiments, the fairlead rollers holder M holds one or more conveyor rollers 105 by securing them to roller holes 1801. In some embodiments, there are a plurality of roller holes 1801 to enable adjustability of the distance between conveyor rollers 105, which may include at least four rollers to protect each roller holder face according to some embodiments.

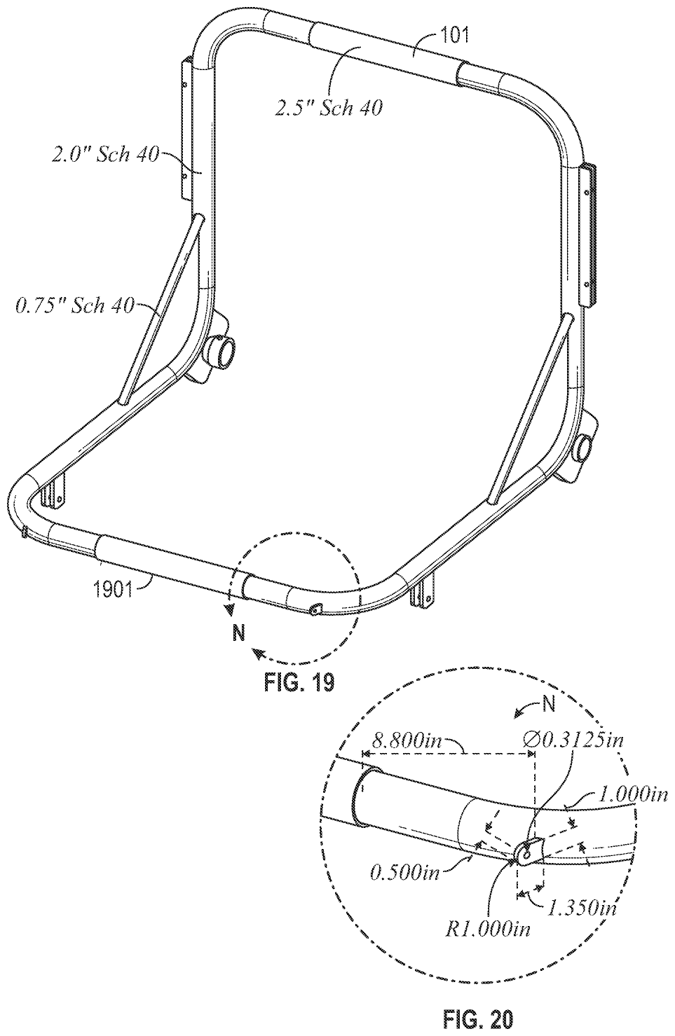

FIG. 19 displays an isometric view of a main frame 101 according to some embodiments.

FIG. 20 exhibits a close-up view of a corner bracketed bar N from the main frame 101 in FIG. 19 according to some embodiments. In some embodiments, the corner bracketed bar N is configured to connect the main frame 101 to a fairlead frame 103 via a chain 402.

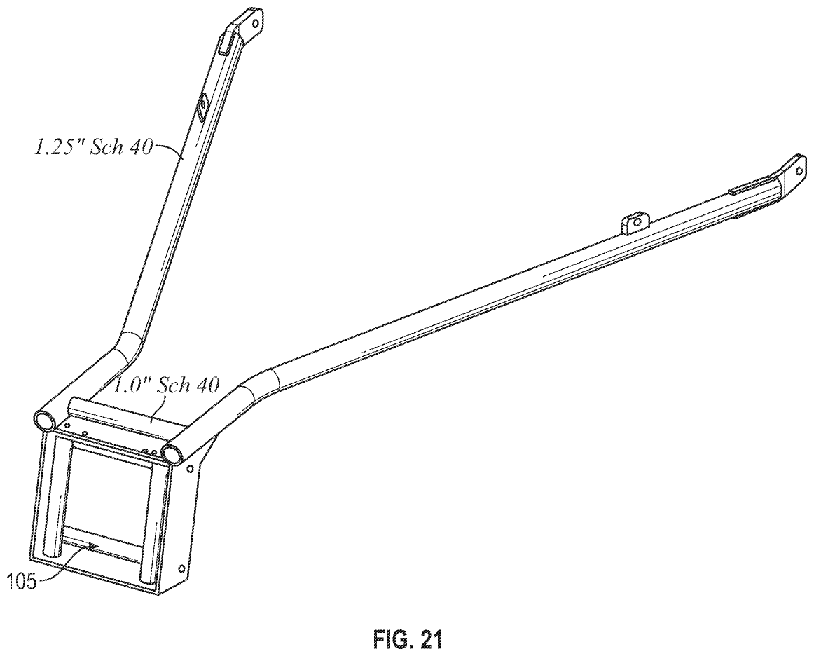

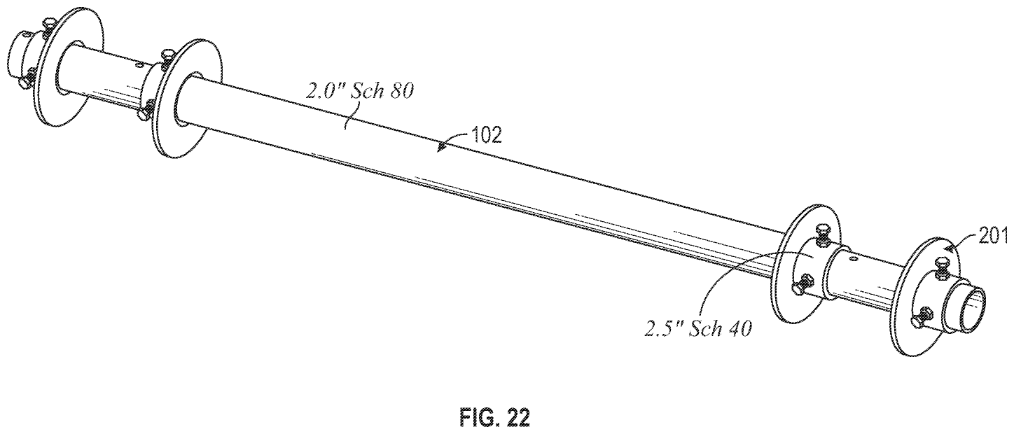

FIG. 21 shows an isometric view of a fairlead frame 103 according to some embodiments. In some embodiments, the fairlead frame is configured to allow easy adjustment of the fairlead opening size by re-positioning the one or more conveyor rollers 105 as desired. In some embodiments, the one or more fastening holes shown in FIG. 18 allow for selective positioning of the one or more rollers 105.

FIG. 22 shows a reel shaft 102 according to some embodiments. In some embodiments, the reel shaft 102 supports a conductor reel 2901 (e.g., cable spool) and is configured to enable the conductor/cable reel 2901 to rotate and dispense the conductor/cable. In some embodiments, the reel shaft 102 has an anti-rotation feature, utilizing a wire-lock 501 (see FIG. 5) to hold the reel shaft 102 in place while the conductor reel 2901 spins to reduce wear of key dolly components such as journals 701.

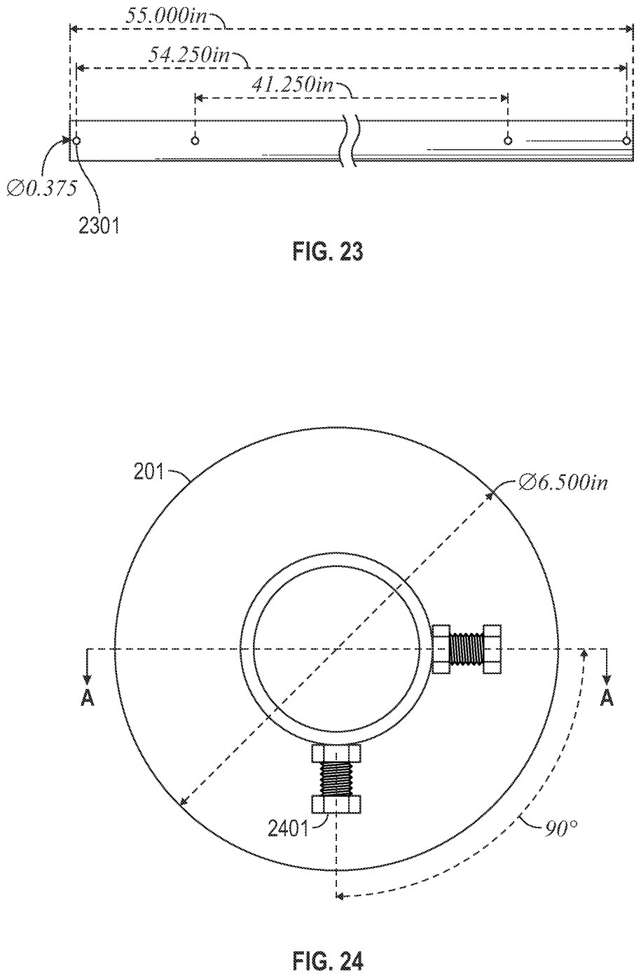

FIG. 23 shows two end portions of the reel shaft 102 in FIG. 22 according to some embodiments. In some embodiments, one or more locking hubs 201 connect to the reel shaft 102 via one or more fasteners coupled to one or more fastener couplings such as the locking holes 2301.

FIG. 24 shows a front view of the locking hub 201 in FIG. 22 according to some embodiments. In some embodiments, the locking hub 201 comprises one or more locking fasteners (e.g., friction bolts as one non-limiting example) 2401 configured to engage locking holes 2301 and/or the surface of reel shaft 102.

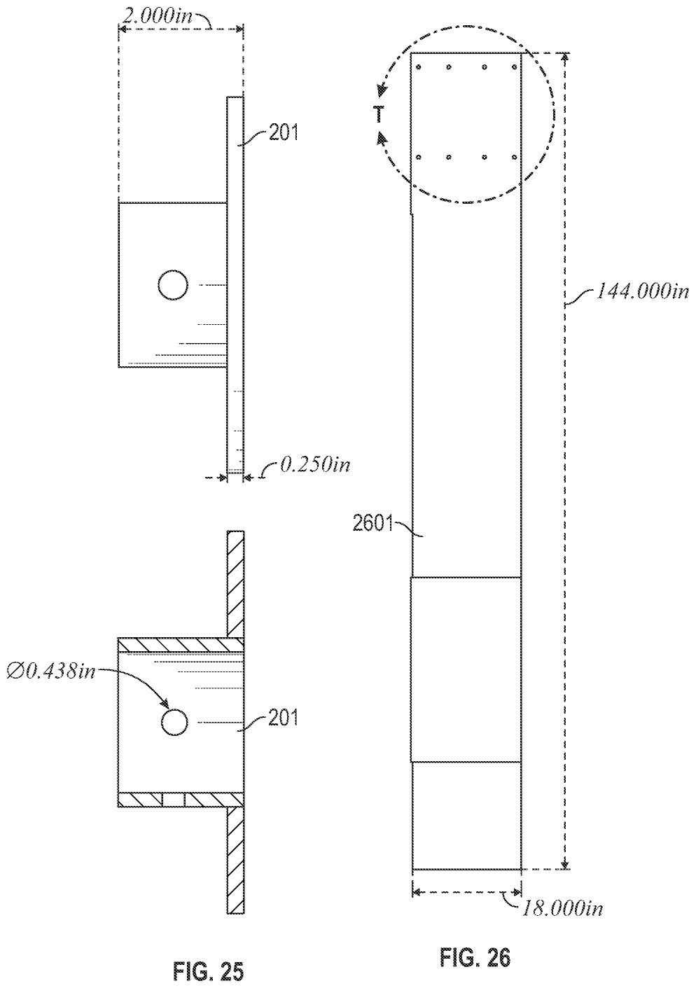

FIG. 25 exhibits a side view of the locking hub 201 according to some embodiments.

FIG. 26 illustrates a brake belt 2601 according to some embodiments. In some embodiments, the brake belt 2601 includes a weighted belt that is configured to provide friction to the conductor reel 102 to control dispensing of a conductor/cable so that it does not unwind too rapidly, get tangled, or become overlapped which could result in binding of the conductor. In some embodiments, the brake belt 2601 is configured to control the amount of friction such that there is not excessive heat or binding generated during payout.

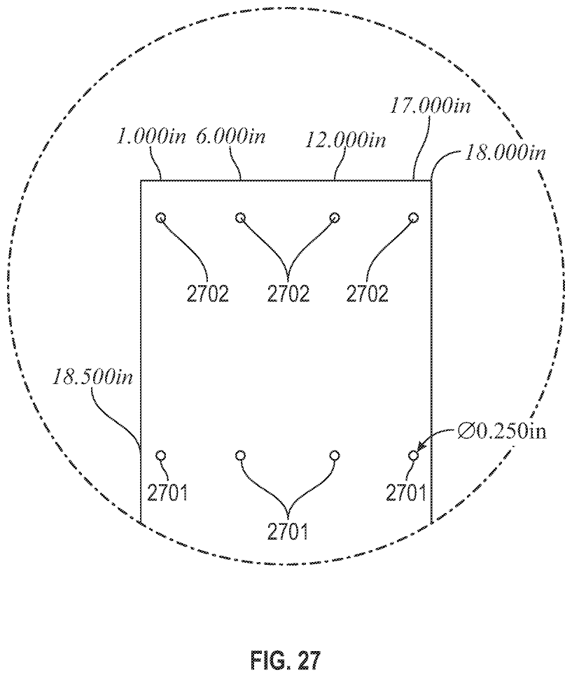

FIG. 27 depicts a zoomed-in portion T of the brake belt 2601 in FIG. 26 according to some embodiments. As shown, a plurality of first holes 2701 (e.g., 8×0.0250″) which enables the brake belt 2601 to secure to itself via second holes 2702 using one or more fasteners (e.g., bolts, pins, etc.). In some embodiments, the loop formed by the connection enables the brake belt 2601 to couple the lead bar 1901 (see FIG. 29).

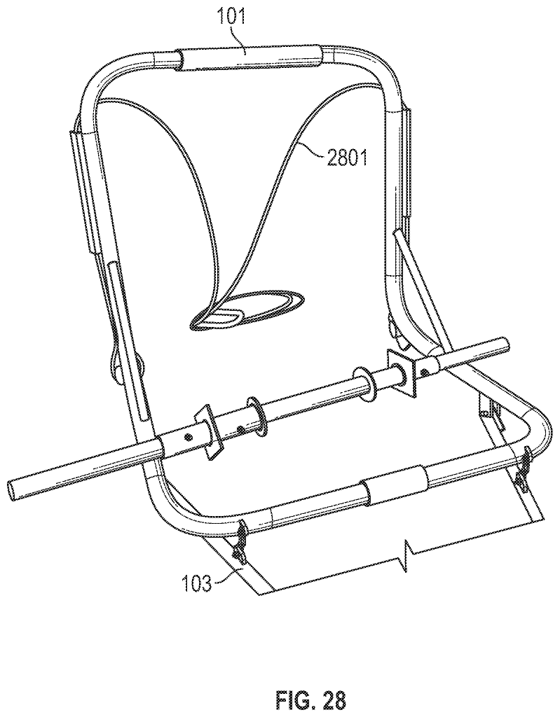

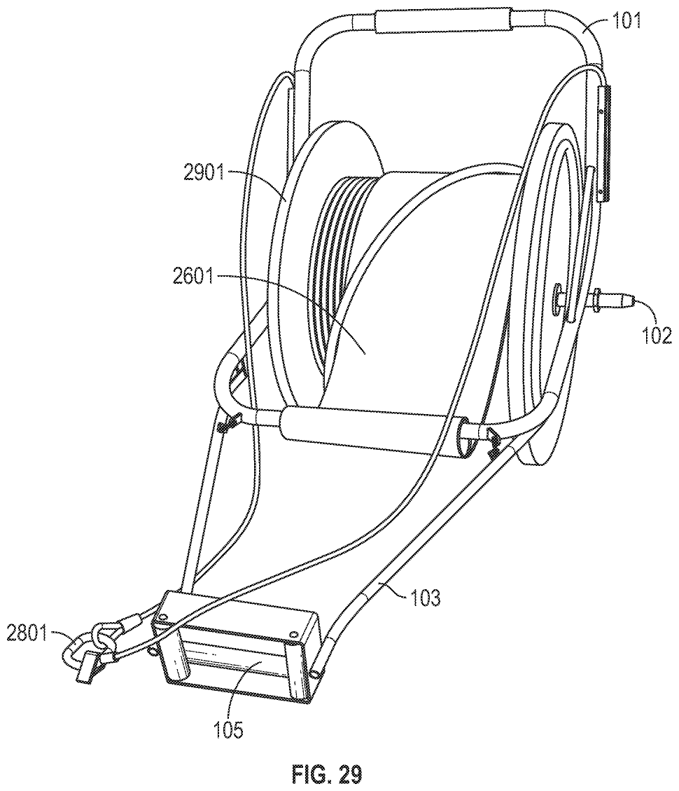

FIG. 28 illustrates a helicopter conductor reel payout dolly stationary on the ground according to some embodiments. As previously described, in some embodiments, the helicopter conductor reel payout dolly comprises a main frame 101, a reel shaft 102, a fairlead frame 103, and a sling 2801.

FIG. 29 shows a helicopter conductor reel payout dolly with a conductor reel 2901 installed according to some embodiments. In some embodiments, the helicopter conductor reel payout dolly comprises a main frame 101, a reel shaft 102, a fairlead frame 103, a brake belt 2601, one or more of a conveyor roller 105, a conductor reel 2901, and a sling 2801. In some embodiments, the conductor reel 2901 is supported by the reel shaft 102. In some embodiments, the brake belt 2601 is weighted and configured to be draped on top of the conductor in the conductor spool generally opposite the fairlead frame 103. In some embodiments, the brake belt 2601 is weighted with one or more removable weights 3001 enabling adjustability of the friction.

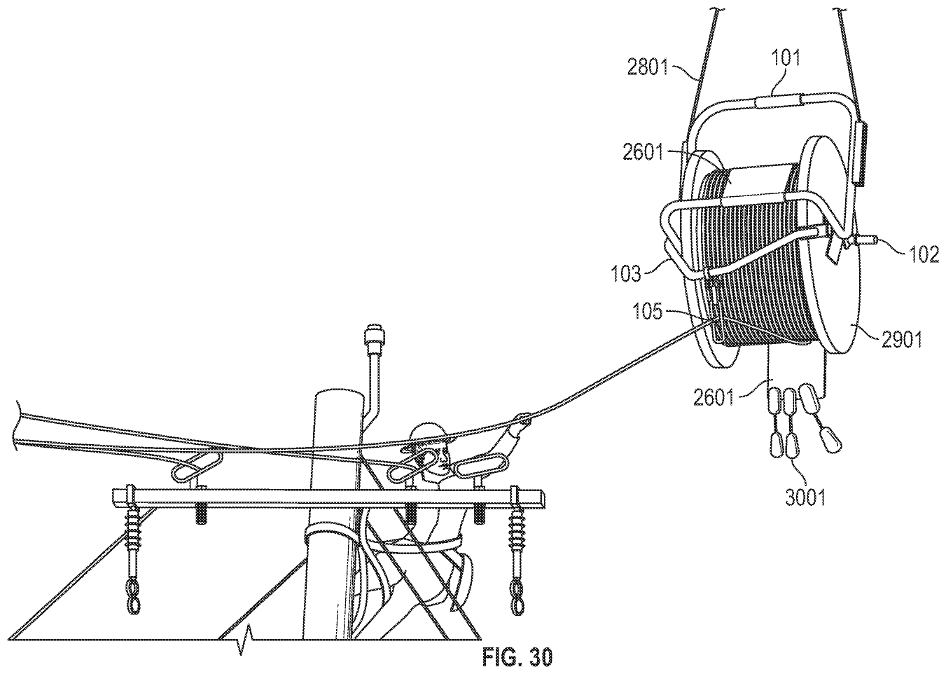

FIG. 30 shows a front view of a helicopter conductor reel payout dolly 100 in use according to some embodiments. In some embodiments, the helicopter conductor reel payout dolly 100 comprises a main frame 101, a reel shaft 102, a fairlead frame 103, a brake belt 2601, one or more of a conveyor roller 105, a conductor reel 2901, and a sling 2801. In some embodiments, the sling 2801 is attached to the main frame 101 and the reel shaft 102 for the helicopter to lift and stabilize the dolly when loaded with the conductor reel 2901. In some embodiments, the conductor is fed around the conductor reel 2901 and through one or more of the conveyor roller 105.

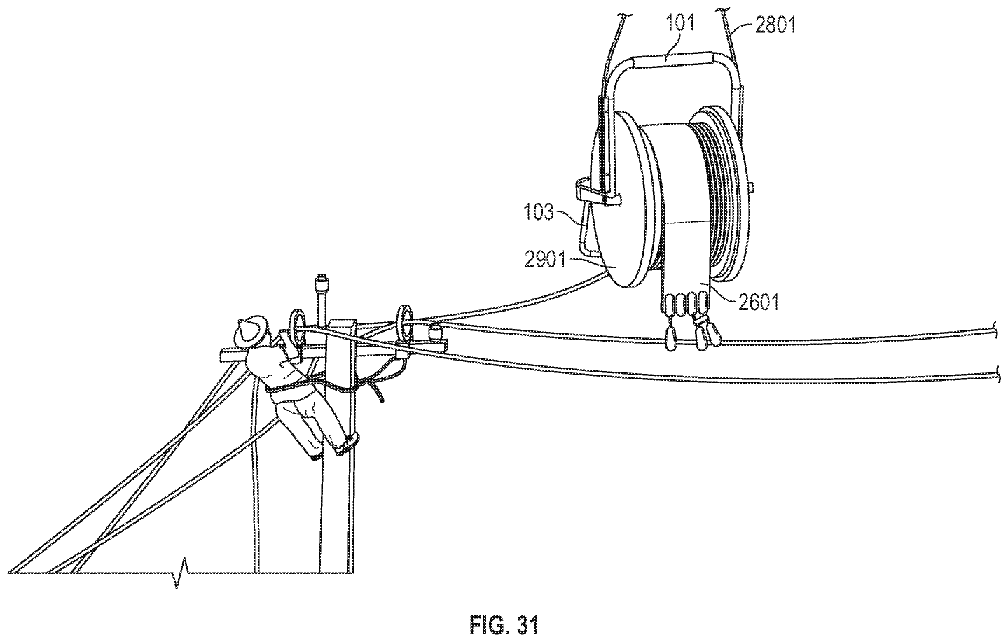

FIG. 31 displays a back view of a helicopter conductor reel payout dolly in use according to some embodiments. In some embodiments, the helicopter conductor reel payout dolly comprises a main frame 101, a reel shaft 102, a fairlead frame 103, a brake belt 2601, one or more of a conveyor roller 105, a conductor reel 2901, and a sling 2801. In some embodiments, the helicopter conductor reel payout dolly is held in the air by the sling 2801 by a helicopter. In some embodiments, the brake belt 2601 is weighted and the weight is configured to be readily modified to change the coefficient of friction based on the type of conductor used to account for variations in friction due to conductor material and insulative coverings, conductor size and weight, etc.

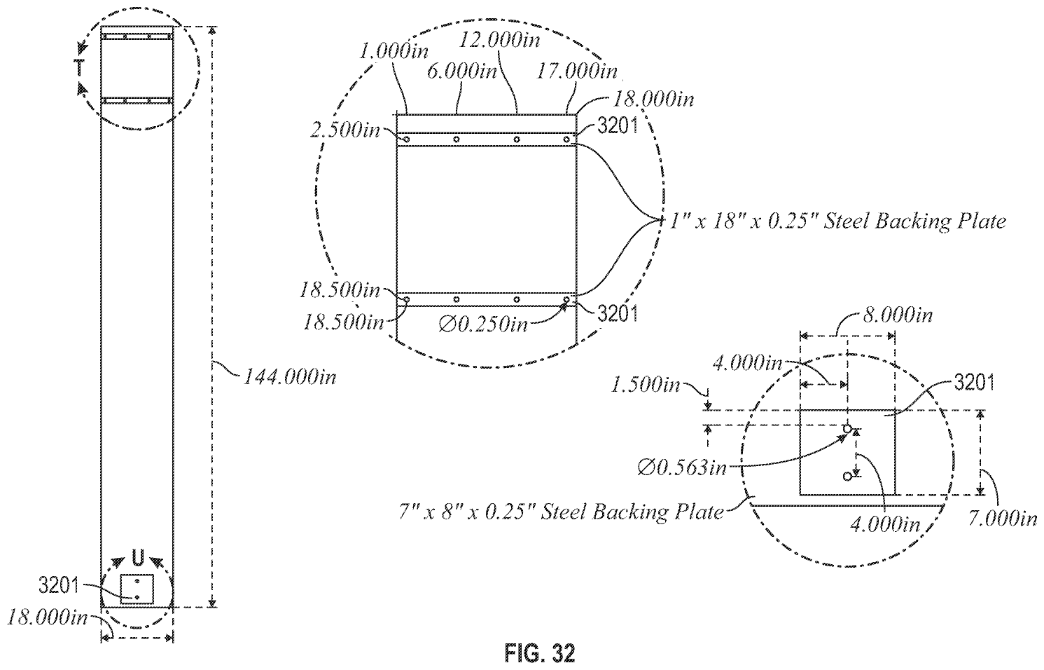

FIG. 32 depicts a brake belt assembly that includes one or more steal backing plates 3201. In some embodiments, the steel backing plates 3201 are configured to be coupled to each other after the brake belt 2601 is looped over the bracketed bar N as previously described. In some embodiments, one or more steel backing plates 3201 comprise one or more fasteners and/or one or more fastener openings configured to enable the brake belt 2601 to attach to itself. In some embodiments, the addition of steel backing plates 3201 to brake belt 2601 mitigates the tearing of brake belt 5.

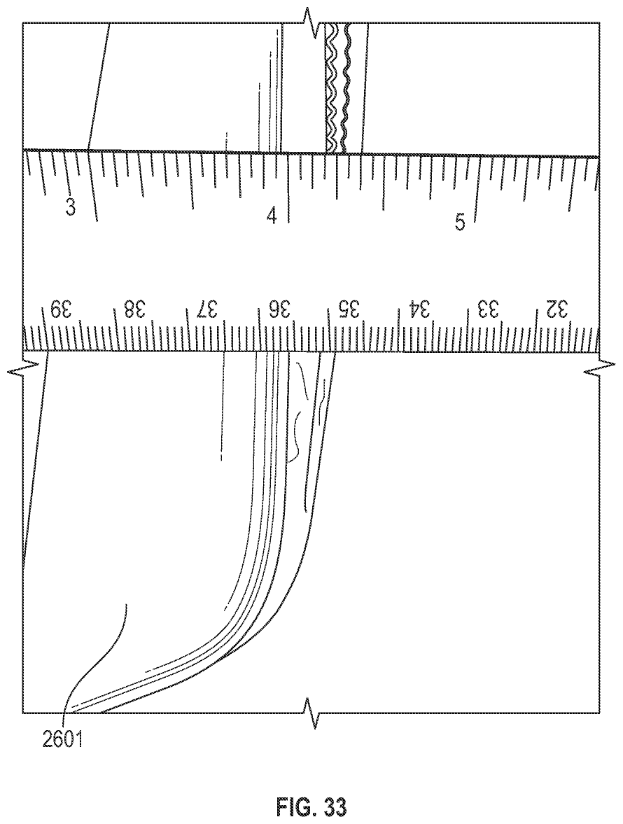

FIG. 33 illustrates a measured thickness of a brake belt 2601 according to some embodiments.

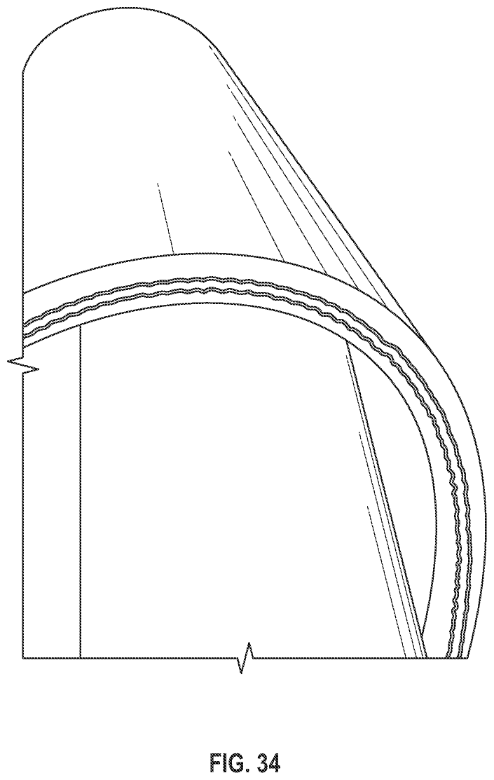

FIG. 34 shows how the brake belt 2601 is configured to connect to the bracketed bar N according to some embodiments. In some embodiments, the brake belt 2601 is configured to attach to itself after wrapping around bracketed bar N, thereby reducing the load on the brake belt fasteners according to some embodiment.

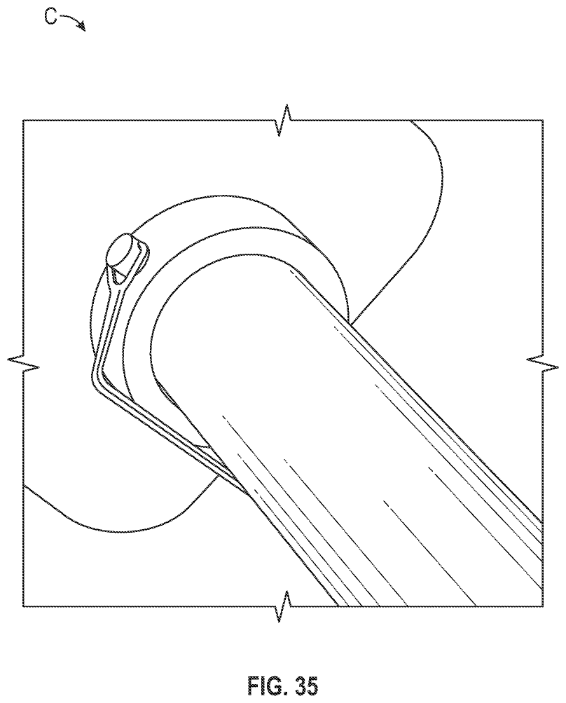

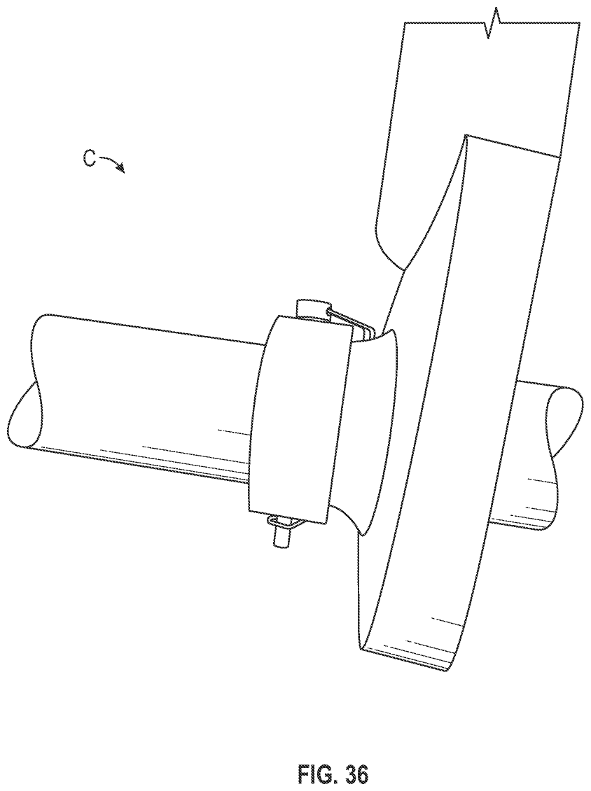

FIG. 35 shows a perspective image of location C from FIG. 2 according to some embodiments.

FIG. 36 shows a top image of location C from FIG. 2 according to some embodiments.

FIG. 37 illustrates the cables attached to sidebar H from FIG. 6 in an assembled helicopter dolly according to some embodiments. In some embodiments, the side bar H includes one or more fasteners 3701 configured to hold the cable within an interior portion of side bar H, as previously described. In some embodiments, one or more fasteners 3701 include one or more wire-locks (e.g., cotter pins).

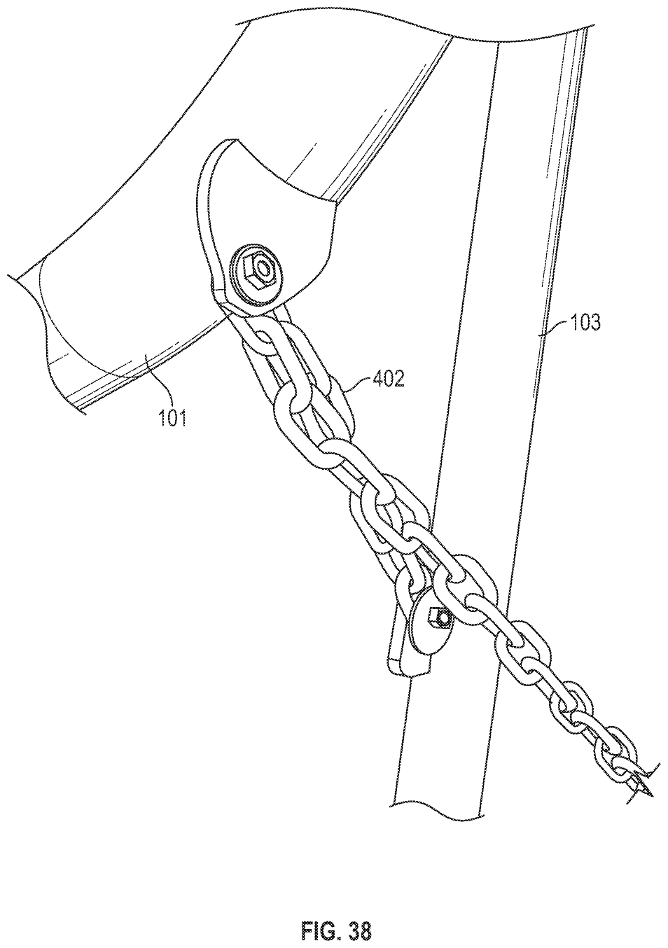

FIG. 38 depicts a close-up view of the support chain 402 from FIG. 4 according to some embodiments.

The subject matter described herein are directed to technological improvements to the field of electrical power line distribution by using a helicopter dolly.

It is understood that the system is not limited in its application to the details of construction and the arrangement of components set forth in the previous description or illustrated in the drawings. The system and methods disclosed herein fall within the scope of numerous embodiments. The previous discussion is presented to enable a person skilled in the art to make and use embodiments of the system. Any portion of the structures and/or principles included in some embodiments can be applied to any and/or all embodiments: it is understood that features from some embodiments presented herein are combinable with other features according to some other embodiments. Thus, some embodiments of the system are not intended to be limited to what is illustrated but are to be accorded the widest scope consistent with all principles and features disclosed herein.

Some embodiments of the system are presented with specific values and/or setpoints. These values and setpoints are not intended to be limiting and are merely examples of a higher configuration versus a lower configuration and are intended as an aid for those of ordinary skill to make and use the system.

Any text in the drawings are part of the system's disclosure and is understood to be readily incorporable into any description of the metes and bounds of the system. Any functional language in the drawings is a reference to the system being configured to perform the recited function, and structures shown or described in the drawings are to be considered as the system comprising the structures recited therein. Any figure depicting a content for display on a graphical user interface is a disclosure of the system configured to generate the graphical user interface and configured to display the contents of the graphical user interface. It is understood that defining the metes and bounds of the system using a description of images in the drawing does not need a corresponding text description in the written specification to fall with the scope of the disclosure.

Furthermore, acting as Applicant's own lexicographer, Applicant imparts the explicit meaning and/or disavow of claim scope to the following terms:

Applicant defines any use of “and/or” such as, for example, “A and/or B,” or “at least one of A and/or B” to mean element A alone, element B alone, or elements A and B together. In addition, a recitation of “at least one of A, B, and C,” a recitation of “at least one of A, B, or C,” or a recitation of “at least one of A, B, or C or any combination thereof” are each defined to mean element A alone, element B alone, element C alone, or any combination of elements A, B and C, such as AB, AC, BC, or ABC, for example.

“Substantially” and “approximately” when used in conjunction with a value encompass a difference of 5% or less of the same unit and/or scale of that being measured.

“Simultaneously” as used herein includes lag and/or latency times associated with a conventional and/or proprietary computer, such as processors and/or networks described herein attempting to process multiple types of data at the same time. “Simultaneously” also includes the time it takes for digital signals to transfer from one physical location to another, be it over a wireless and/or wired network, and/or within processor circuitry.

As used herein, “can” or “may” or derivations there of (e.g., the system display can show X) are used for descriptive purposes only and is understood to be synonymous and/or interchangeable with “configured to” (e.g., the computer is configured to execute instructions X) when defining the metes and bounds of the system. The phrase “configured to” also denotes the step of configuring a structure or computer to execute a function in some embodiments.

In addition, the term “configured to” means that the limitations recited in the specification and/or the claims must be arranged in such a way to perform the recited function: “configured to” excludes structures in the art that are “capable of” being modified to perform the recited function but the disclosures associated with the art have no explicit teachings to do so. For example, a recitation of a “container configured to receive a fluid from structure X at an upper portion and deliver fluid from a lower portion to structure Y” is limited to systems where structure X, structure Y, and the container are all disclosed as arranged to perform the recited function. The recitation “configured to” excludes elements that may be “capable of” performing the recited function simply by virtue of their construction but associated disclosures (or lack thereof) provide no teachings to make such a modification to meet the functional limitations between all structures recited. Another example is “a computer system configured to or programmed to execute a series of instructions X, Y, and Z.” In this example, the instructions must be present on a non-transitory computer readable medium such that the computer system is “configured to” and/or “programmed to” execute the recited instructions: “configure to” and/or “programmed to” excludes art teaching computer systems with non-transitory computer readable media merely “capable of” having the recited instructions stored thereon but have no teachings of the instructions X, Y, and Z programmed and stored thereon. The recitation “configured to” can also be interpreted as synonymous with operatively connected when used in conjunction with physical structures.

It is understood that the phraseology and terminology used herein is for description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

The previous detailed description is to be read with reference to the figures, in which like elements in different figures have like reference numerals. The figures, which are not necessarily to scale, depict some embodiments and are not intended to limit the scope of embodiments of the system.

Although method operations are presented in a specific order according to some embodiments, the execution of those steps do not necessarily occur in the order listed unless explicitly specified. Also, other housekeeping operations can be performed in between operations, operations can be adjusted so that they occur at slightly different times, and/or operations can be distributed in a system which allows the occurrence of the processing operations at various intervals associated with the processing, as long as the processing of the overlay operations are performed in the desired way and result in the desired system output.

It will be appreciated by those skilled in the art that while the invention has been described above in connection with particular embodiments and examples, the invention is not necessarily so limited, and that numerous other embodiments, examples, uses, modifications and departures from the embodiments, examples and uses are intended to be encompassed by the claims attached hereto. The entire disclosure of each patent and publication cited herein is incorporated by reference, as if each such patent or publication were individually incorporated by reference herein. Various features and advantages of the invention are set forth in the following claims.

We claim:

1. A dolly for unrolling a cable reel supported by an aircraft capable of hovering, comprising:
a main frame,
a fairlead frame, and
a reel shaft;
wherein the main frame is configured to hold the reel shaft;
wherein the main frame is configured to hold the cable reel;
wherein the fairlead frame is pivotably attached to the main frame; and
wherein the fairlead frame is configured to guide a cable away from the cable reel.

2. The dolly of claim 1,
further comprising a tether configured to limit a pivot range between the main frame and the fairlead frame.

3. The dolly of claim 1,
further comprising a brake belt.

4. The dolly of claim 3,
wherein the brake belt is configured to limit a rotation of the cable reel about the reel shaft.

5. The dolly of claim 3,
wherein the brake belt includes one or more detachable weights configured to increase friction on the cable reel.

6. The dolly of claim 1,
wherein the fairlead frame comprises one or more rollers.

7. The dolly of claim 6,
wherein the one or more rollers are configured to guide the cable away from the cable reel.

8. The dolly of claim 1,
wherein the main frame comprises one or more cable guides.

9. The dolly of claim 8,
wherein the one or more cable guides are configured to secure a tether to the main frame.

10. The dolly of claim 8,
wherein the one or more cable guides comprise a plurality of fasteners.

11. The dolly of claim 10,
wherein the plurality of fasteners are configured to confine a tether between walls of the one or more cable guides.

12. The dolly of claim 1,
wherein the main frame further includes one or more journal plates configured to support a journal.

13. The dolly of claim 12,
wherein the one or more journal plates include a journal configured to support the reel shaft.

14. The dolly of claim 13,
wherein the journal includes one or more fasteners configured to prevent rotation of the reel shaft.

15. The dolly of claim 9,
further comprising one or more locking hubs.

16. The dolly of claim 15,
wherein each of the one or more locking hubs is configured to secure the tether to the reel shaft.

17. The dolly of claim 15,
wherein each of the one or more locking hubs is configured to prevent the tether from sliding off the reel shaft.

18. The dolly of claim 15,
wherein each of the one or more locking hubs comprise fasteners configured to prevent a lateral and/or rotational movement when coupled to the reel shaft.
